(19) United States
(12) Patent Application Publication
(10) Pub. No.: US 2006/0202917 A1
(43) Pub. Date: Sep. 14, 2006

(54) Plasma display apparatus and driving method thereof

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/367,442

(22) Filed: Mar. 6, 2006

(30) Foreign Application Priority Data
Mar. 8, 2005 (KR) 10-2005-0019372
Mar. 8, 2005 (KR) 10-2005-0019373

(51) Int. Cl. G09G 3/28

(52) U.S. Cl. 345/60

(57) ABSTRACT

Provided are a plasma display apparatus and a driving method thereof. The apparatus comprises a plasma display panel, and a single sustain driving board. The plasma display panel comprises a scan electrode and a sustain electrode. The single sustain driving board comprises a single energy recovery circuit unit and a single sustain pulse creation unit. The single energy recovery circuit unit supplies energy for supplying a sustain pulse through a same energy storing unit and a same inductor to the scan electrode and to the sustain electrode. The single sustain pulse creation unit supplies the sustain pulse to the scan electrode and to the sustain electrode.

This Nonprovisional application claims priority under 35 U.S.C. §119(a) on Patent Application Nos. 10-2005-0019372 and 10-2005-0019373 filed in Korea on Mar. 8, 2005 the entire contents of which are hereby incorporated by reference.

### BACKGROUND OF THE INVENTION

1. Field of the Invention

The present invention relates to a plasma display apparatus and a driving method thereof.

2. Description of the Background Art

In general, in a plasma display panel, barrier ribs formed between a front panel and a rear panel form one unit cell. Main discharge gas such as neon (Ne), helium (He) or a mixture (He+Ne) of neon and helium and inert gas containing a small amount of xenon (Xe) are filled in each cell. When discharge is performed using radio frequency voltage, the inert gas generates vacuum ultraviolet rays and phosphors provided between the barrier ribs are emitted, thereby embodying images. The plasma display panel is attracting attention as a next generation display apparatus due to its slimness and lightweigtness.

FIG. 1 is a diagram illustrating conventional connection relation between a plasma display panel and a driver.

As shown in FIG. 1, a front panel 151 and a rear panel 152 are sealed with each other, thereby forming a plasma display panel 150. A scan driver board 111, a scan electrode (Y) sustain driving board 112, a sustain electrode (Z) sustain driving board 120, a data driver board 130, a control board 140, and a power source board (not shown) are formed on a frame 100 provided in rear of the plasma display panel 150.

The scan driver board 111 supplies a scan pulse and a reset pulse to scan electrode lines (Y1 to Ym) provided at the plasma display panel 150, through a flexible printed circuit 113 (FPC).

The Y sustain driving board 112 supplies a Y sustain pulse to the scan electrode lines (Y1 to Ym) through the scan driver board 111 and the FPC 113.

The data driver board 130 supplies a data pulse to data electrode lines (X1 to Xn) of the plasma display panel 150 through a film type device 131.

The Z sustain driving board 120 supplies a bias pulse and a Z sustain pulse to sustain electrode lines (Z1 to Zm) of the plasma display panel 150 through a FPC 121.

As a driving board for supplying a driving pulse of a sustain period, for example, a sustain pulse, there are the Y sustain driving board 112 and the Z sustain driving board 120. In case where the driving board is formed at each electrode, there is a drawback in that electromagnetic interference (EMI) or interference caused by phase error of a pulse applied between respective electrodes. Further, manufacture cost of a plasma display apparatus is increased. In addition, there is drawback of increasing noise of a driving waveform due to increase of output impedance caused by use of a high voltage switch.

### SUMMARY OF THE INVENTION

Accordingly, an object of the present invention is to solve at least the problems and disadvantages of the background art.

An object of the present invention is to provide a plasma display apparatus and a driving method thereof for reducing manufacture cost.

Another object of the present invention is to provide a plasma display apparatus and a driving method thereof for reducing number of circuit logics, and reducing number of circuit devices.

A further another object of the present invention is to provide a plasma display apparatus and a driving method thereof for improving reliability of driving.

To achieve these and other advantages and in accordance with the purpose of the present invention, as embodied and broadly described, there is provided a plasma display apparatus comprising a plasma display panel, and a single sustain driving board. The plasma display panel may comprise a scan electrode and a sustain electrode. The single sustain driving board may comprise a single energy recovery circuit unit and a single sustain pulse creation unit. The single energy recovery circuit unit may supply energy for supplying a sustain pulse through a same energy storing unit and a same inductor to the scan electrode and to the sustain electrode. The single sustain pulse creation unit may supply the sustain pulse to the scan electrode and to the sustain electrode.

In another aspect of the present invention, there is provided a plasma display apparatus comprising a plasma display panel, a single energy recovery circuit unit, a first switch unit, and a second switch unit. The plasma display panel may comprise a scan electrode and a sustain electrode. The single energy recovery circuit unit may control the application of a sustain pulse to the scan electrode and the sustain electrode. The first switch unit may connect between the single energy recovery circuit and the scan electrode, and may control the application of a sustain pulse to the scan electrode. The second switch unit may commonly connect at one end between the single energy recovery circuit and the first switch unit and may connect at the other end to the sustain electrode. The second switch unit may control the application of the sustain pulse to the sustain electrode.

In a further another aspect of the present invention, there is provided a plasma display apparatus comprising a plasma display panel, a single energy recovery circuit unit, a first switch unit, and a second switch unit. The plasma display panel may comprise a plurality of scan electrodes and a plurality of sustain electrodes. The single energy recovery circuit unit may control the application of a sustain pulse to the scan electrodes and the sustain electrodes. The first switch unit may simultaneously supply a first sustain pulse to a first scan electrode group of the plurality of scan electrodes and a second sustain electrode group of the plurality of sustain electrodes. The second switch unit may alternately supply a second sustain pulse to a second scan electrode group of the plurality of scan electrodes and to a first sustain electrode group of the plurality of sustain electrodes.

In a still further another aspect of the present invention, there is provided a driving method of a plasma display apparatus comprising a plasma display panel comprising a scan electrode and a sustain electrode. The method may comprise the steps of supplying energy for supplying of a sustain pulse from a single energy recovery circuit to the scan electrode and the sustain electrode, and generating a pulse with a frequency of about two times a frequency of a sustain pulse applied to the scan electrode and the sustain electrode from a single sustain pulse generator.

The inventive plasma display apparatus is constituted of a single driving board and therefore, gives effect of reducing manufacture cost.

The present invention drives scan electrode lines and sustain electrode lines using the integration sustain circuit, thereby giving effect of reducing electromagnetic interference (EMI) or interference caused by phase difference between two electrodes.

The present invention has effect of reducing number of circuit logics, and reducing number of circuit devices.

The present invention has effect of improving driving reliability.

### BRIEF DESCRIPTION OF THE DRAWINGS

The embodiment of the invention will be described in detail with reference to the following drawings in which like numerals refer to like elements.

FIG. 1 is a diagram illustrating conventional connection relation between a plasma display panel and a driver;

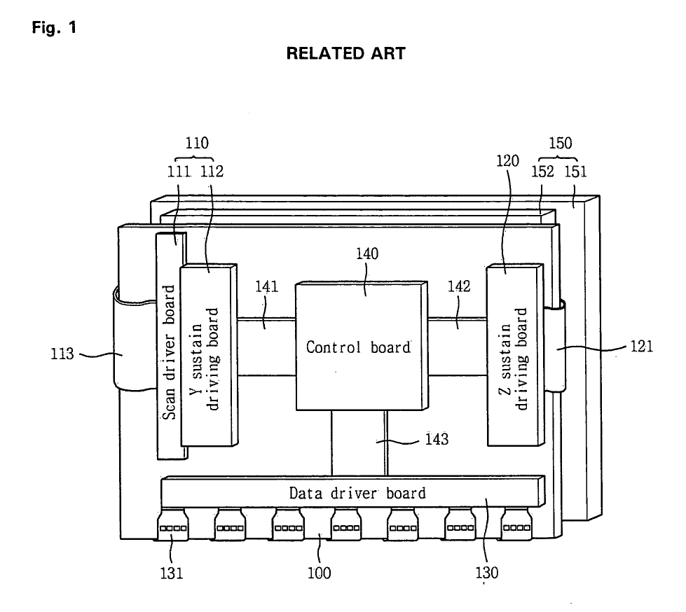

FIG. 2 is a diagram illustrating connection relation between a plasma display panel and a driver according to an embodiment of the present invention;

FIG. 3 is a diagram illustrating an example of a driving method of a plasma display apparatus according to the present invention;

FIG. 4 is a diagram illustrating a single sustain driving board of a plasma display apparatus according to a first embodiment of the present invention;

FIG. 5 is a diagram illustrating an example of a construction of a Y-Z integration sustain circuit unit of FIG. 4;

FIG. 6 is a diagram illustrating switch timing of the plasma display apparatus of FIG. 4 according to a first embodiment of the present invention;

FIG. 7 is a diagram illustrating switch timing of the plasma display apparatus of FIG. 4 according to a second embodiment of the present invention;

FIG. 8 is a diagram illustrating a single sustain driving board of a plasma display apparatus according to a second embodiment of the present invention;

FIG. 9 is a diagram illustrating switch timing of the plasma display apparatus of FIG. 8 according to a first embodiment of the present invention;

FIG. 10 is a diagram illustrating switch timing of the plasma display apparatus of FIG. 8 according to a second embodiment of the present invention;

FIG. 11 is a diagram illustrating switch timing of the plasma display apparatus of FIG. 8 according to a third embodiment of the present invention;

FIG. 12 is a diagram illustrating switch timing of the plasma display apparatus of FIG. 8 according to a fourth embodiment of the present invention;

FIG. 13 is a diagram illustrating connection relation between a plasma display panel and a driver according to another embodiment of the present invention; and

FIG. 14 is a diagram illustrating connection relation between a plasma display panel and a driver according to a further embodiment of the present invention.

### DETAILED DESCRIPTION OF PREFERRED EMBODIMENTS

Preferred embodiments of the present invention will be described in a more detailed manner with reference to the drawings.

In an aspect of the present invention, there is provided a plasma display apparatus comprising: a plasma display panel comprising a scan electrode and a sustain electrode; and a single sustain driving board comprising a single energy recovery circuit unit for supplying energy to supply a sustain pulse through a same energy storing unit and a same inductor to the scan electrode and to the sustain electrode, and a single sustain pulse creation unit for supplying the sustain pulse to the scan electrode and to the sustain electrode.

The single sustain driving board comprises a switch unit, one end connecting to the scan electrode and the sustain electrode and the other end connecting to the single energy recovery circuit unit, for alternately supplying the sustain pulse to the scan electrode and the sustain electrode.

The switch unit comprises a first switch unit and a second switch unit that turn on in a push-pull form for alternately supplying the sustain pulse to the scan electrode and the sustain electrode.

One end of the single sustain driving board connects to the scan electrode through an electrode pad and the other end connects to a plurality of sustain electrodes, that are commonly connected, through a common electrode line.

The common electrode line is a plurality of common electrode lines, wherein each common electrode line that connects to an amount the sustain electrodes that is less the total number of sustain electrodes in the plurality of sustain electrodes.

The number of common electrode lines equals two.

In another aspect of the present invention, there is provided a plasma display apparatus comprising: a plasma display panel comprising a scan electrode and a sustain electrode; a single energy recovery circuit unit for controlling the application of a sustain pulse to the scan electrode and the sustain electrode; a first switch unit, connected between the single energy recovery circuit and the scan electrode, for controlling the application of a sustain pulse to the scan electrode; and a second switch unit, one end commonly connecting between the single energy recovery circuit and the first switch unit and the other end connecting to the sustain electrode, for controlling the application of the sustain pulse to the sustain electrode.

The single energy recovery circuit comprises a common energy storing unit for recovering and storing the energy to supply the sustain pulse to the scan electrode and the sustain electrode; and a common inductor for supplying the energy stored in the common energy storing unit to the scan electrode and the sustain electrode.

The plasma display apparatus further comprises a scan driver IC connected between the first switch unit and the scan electrode.

The single energy recovery circuit unit, the first switch unit, the second switch unit and the scan driver are formed on a single driving board.

The supplying of a sustain pulse to the scan electrode turns on the first switch unit, and the supplying of a sustain pulse to the sustain electrode turns on the second switch unit.

The duration of time that each of the first and second switch units remains turned on is substantially the same as the duration of time for supplying the sustain pulse.

The first switch unit in an on state turns off between a time point when the application of one sustain pulse to the scan electrode terminates and an application time point of one sustain pulse to the sustain electrode after applying one sustain pulse to the scan electrode, and the second switch unit in an on state turns off between a time point when the application of one sustain pulse to the sustain electrode terminates and an application time point of one sustain pulse to the scan electrode after applying one sustain pulse to the sustain electrode.

In a further another aspect of the present invention, there is provided a plasma display apparatus comprising: a plasma display panel comprising a plurality of scan electrodes and a plurality of sustain electrodes; a single energy recovery circuit unit for controlling the application of a sustain pulse to the scan electrodes and the sustain electrodes; a first switch unit for simultaneously supplying a first sustain pulse to a first scan electrode group of the plurality of scan electrodes and a second sustain electrode group of the plurality of sustain electrodes; and a second switch unit for alternately supplying a second sustain pulse to a second scan electrode group of the plurality of scan electrodes and to a first sustain electrode group of the plurality of sustain electrodes.

The single energy recovery circuit comprises a common energy storing unit for recovering and for storing energy to supply the sustain pulse to the scan electrode and the sustain electrode; and a common inductor for supplying the energy stored in the common energy storing unit to the scan electrode and the sustain electrode.

The plasma display apparatus further comprises a first scan driver, connected between the first switch unit and the first scan electrode group; and a second scan driver, connected between the second switch unit and the second scan electrode group.

One end of the first switch unit connects to the single energy recovery circuit unit and the other end commonly connects to the first scan driver and the second sustain electrode group, and one end of the second switch unit commonly connects between the single energy recovery circuit and the first switch unit and the other end commonly connects to the second scan driver and the first sustain electrode group.

The single energy recovery circuit unit, the first switch unit, the second switch unit and the scan driver are formed on a single driving board.

The first scan electrode group is formed on an upper half portion of the plasma display panel and the second scan electrode group is formed on a lower half portion of the plasma display panel, and the first sustain electrode group is formed on the upper half portion of the plasma display panel and the second sustain electrode group is formed on the lower half portion of the plasma display panel.

The supplying of the first sustain pulse to the first scan electrode group and the second sustain electrode group turns on the first switch unit, and the supplying of the second sustain pulse to the second scan electrode group and the first sustain electrode group turns on the second switch unit.

The duration of time that each of the first and second switch units remains turned on is substantially the same as the duration of time for supplying the sustain pulse.

The first switch unit in an on state turns off between a time point when the application of one sustain pulse to the scan electrode terminates and an application time point of one sustain pulse to the sustain electrode after applying one sustain pulse to the scan electrode, and the second switch unit in an on state turns off between a time point when the application of one sustain pulse to the sustain electrode terminates and an application time point of one sustain pulse to the scan electrode after applying one sustain pulse to the sustain electrode.

In a still further another aspect of the present invention, there is provided a driving method of a plasma display apparatus comprising a plasma display panel comprising a scan electrode and a sustain electrode, the method comprising the steps of: supplying energy to supply a sustain pulse from a single energy recovery circuit to the scan electrode and the sustain electrode; and generating a pulse with a frequency of about two times a frequency of a sustain pulse applied to the scan electrode and the sustain electrode from a single sustain pulse generator.

The switch unit alternately supplies the sustain pulse to the scan electrode and the sustain electrode through predetermined switching operation.

The duration of time that the switch unit remains turned on is substantially the same as about two times of the duration of time for supplying the sustain pulse.

An embodiment of the present invention will be described below with reference to the accompanying drawing.

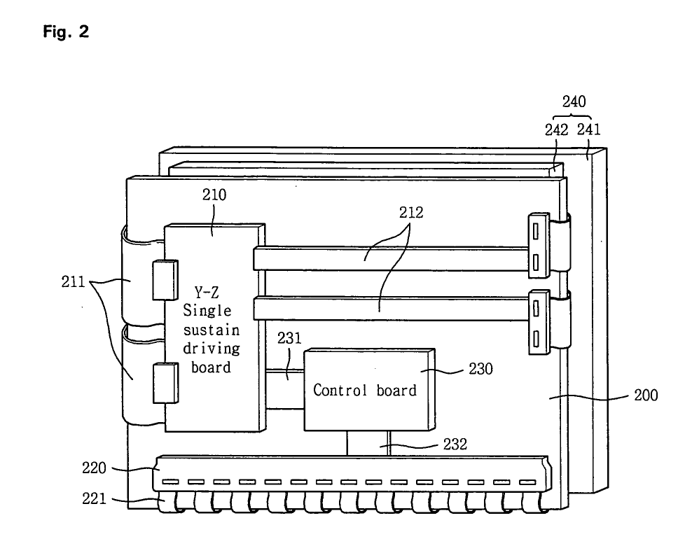

FIG. 2 is a diagram illustrating connection relation between a plasma display panel and a driver according to an embodiment of the present invention.

As shown in FIG. 2, the inventive plasma display apparatus can comprise a plasma display panel 240 having a front panel 241 and a rear panel 242 sealed with each other, and displaying images; a frame 200 provided in rear of the plasma display panel 240; and a single sustain driving board 210, a data driver board 220, a control board 230, and a supply source board (not shown) capable of being provided on the frame 200.

Discharge gas is filled in space between the front and rear panels 241 and 242 sealed with each other. Further, for example, the front panel 241 comprises scan electrode (Y) lines (not shown) and sustain electrode (Z) lines (not shown), which are provided side by side a long a long axis of the plasma display panel of FIG. 2. For example, the rear panel 242 comprises data electrode (X) lines provided to intersect with a scan electrode (Y) and a sustain electrode (Z) in a short axis of the plasma display panel of FIG. 2. A discharge cell is provided at a position corresponding to an intersection point of the scan electrode (Y), the sustain electrode (Z), and a data electrode (X), and generates discharge and embodies the images.

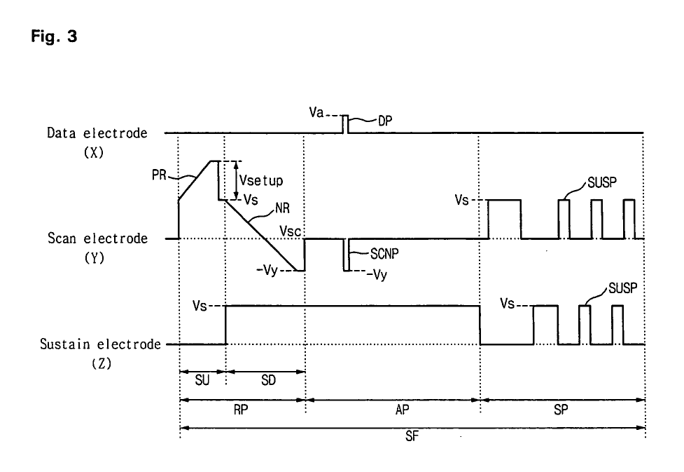

The single sustain driving board 210 can apply a driving pulse to the scan electrode and the sustain electrode. In other words, all of two electrodes can be driven using one driving board. A detailed construction thereof will be later described with reference to FIG. 3 below.

The single sustain driving board 210 can connect at its one side with the scan electrodes (Y) through an electrode pad 211 and apply driving pulses, such as a reset pulse, a scan pulse, and a sustain pulse, to the scan electrodes (Y). The single sustain driving board 210 can connect at its other side with the sustain electrodes (Z) commonly connected through a common electrode line 212, and apply a bias pulse and a sustain pulse to the sustain electrodes (Z).

The electrode pad 211 can be formed using a flexible printed circuit (FPC), for example. The common electrode line 212 can be provided in plural and connected with some of a plurality of the sustain electrodes (Z) in order to reduce load of the plasma display panel 240.

For example, the common electrode line 212 is divided as two lines, and the plurality of sustain electrodes (Z) are divided as two groups so that the two sustain electrode groups can connect with the two common electrode lines, respectively. The dividing of the common electrode line 212 as plural lines is to reduce the panel load. In other words, as the plasma display panel is increased in size, large current is generated and the load applied to the common electrode line 212 is increased. By dividing the common electrode line 212 as plural ones, line resistance can be reduced. Accordingly, a load difference between the sustain electrodes (Z) can be reduced, thereby enhancing reliability of driving.

The data driver board 220 supplies the data pulse to the data electrode (X) lines of the plasma display panel 240 through a film type device 221. The film type device 221 can be formed using a chip on film (COF) or a tape carrier package (TCP) having connection wiring.

The control board 230 generates timing control signals for controlling the single sustain driving board 210 and the data driver board 220, respectively.

The control board 230 supplies a scan electrode (Y) timing control signal and a sustain electrode (Z) timing control signal to the single sustain driving board 210 via the FPC 231, and supplies a data electrode (X) timing control signal to the data driver board 220 via the FPC 232.

The supply source board supplies a power source to the boards 210, 220, and 230, respectively.

The single sustain driving board 210, the data driver board 220, the control board 230, and the power source board is couple to the frame 200 using a plurality of bosses (not shown).

The frame 200 can be installed to wholly superpose with a rear surface of the plasma display panel 240, and serve to emit heat generated from the plasma display panel 240 and the driving boards 210, 220, and 230 to the outside.

An example of a driving waveform of the inventive plasma display apparatus will be described with reference to FIG. 3 below. The driving waveform of FIG. 3 is to help understanding of a more detailed construction of the inventive plasma display apparatus. It should be noted that the present invention is not limited to such a driving method.

FIG. 3 is a diagram illustrating an example of the driving method of the plasma display apparatus according to the present invention.

FIG. 3 shows the driving waveform illustrating an example of the driving method in one of a plurality of subfields (SF) embodied by the inventive plasma display apparatus.

Referring to FIG. 3, each subfield (SF) is divided into a reset period (RP) for initializing a discharge cell of a whole screen, an address period (AP) for selecting the discharge cell, and a sustain period (SP) for sustaining discharge of the selected discharge cell and embodying the images.

In a setup period (SU) of the reset period (RP), a ramp-up waveform (PR) rising along a predetermined slope from a sustain voltage (Vs) to a peak voltage (Vs+Vsetup) is applied to all of the scan electrode (Y) lines at the same time. Owing to the ramp-up waveform (PR), weak discharge occurs and wall charges are generated within cells of a whole screen. In a setdown period (SD), a ramp-down waveform (NR) falling from the positive (+) sustain voltage (Vs) lower than the peak voltage (Vs+Vsetup) of the ramp-up waveform (PR) to a negative scan voltage (−Vy) is applied to all of the scan electrode (Y) lines at the same time. The ramp-down waveform (NR) generates weak erasure discharge within the cells, thereby erasing the wall charges generated by the setup discharge and unnecessary ones of space charges, and uniformly making remain the wall charges, which are necessary for address discharge, within the cells of the whole screen.

In the address period (AP), a negative (−) scan pulse (SCNP) is sequentially applied to the scan electrode (Y) lines and at the same time, a positive (+) data pulse (DP) is applied to the data electrode (X) lines. Voltage difference between the scan pulse (SCNP) and the data pulse (DP) is added to wall voltage generated in the reset period (RP) while the address discharge is generated within the cell where the data pulse (DP) is applied. The wall charges are generated within the cell selected by the address discharge.

Meantime, during the setdown period (SD) and the address period (AP), the positive (+) sustain voltage (Vs) is applied to the sustain electrode (Z) lines.

In the sustain period (SP), the sustain pulse is alternately applied to the scan electrode (Y) lines and the sustain electrode (Z) lines. If so, in the cell selected by the address discharge, the wall voltage within the cell is added with the sustain pulse (SUSP) and, whenever the sustain pulse (SUSP) is applied, sustain discharge is generated in a surface discharge form between the scan electrode (Y) and the sustain electrode (Z). The sustain pulses (SUSPs) have the same voltage as the sustain voltage (Vs).

Plasma display apparatuses according to several embodiments of the present invention will be described with reference to the drawings below.

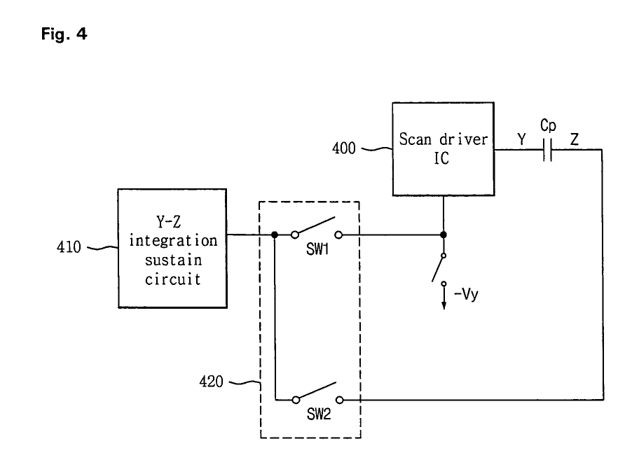

FIG. 4 is a diagram illustrating a single sustain driving board 210 of a plasma display apparatus according to a first embodiment of the present invention.

As shown in FIG. 4, The plasma display apparatus according to an embodiment of the present invention comprises an equivalent capacitor (Cp) of the plasma display panel and the single sustain driving board 210. The single sustain driving board 210 may comprise a Y-Z integration sustain circuit unit 410 and a switch unit 420.

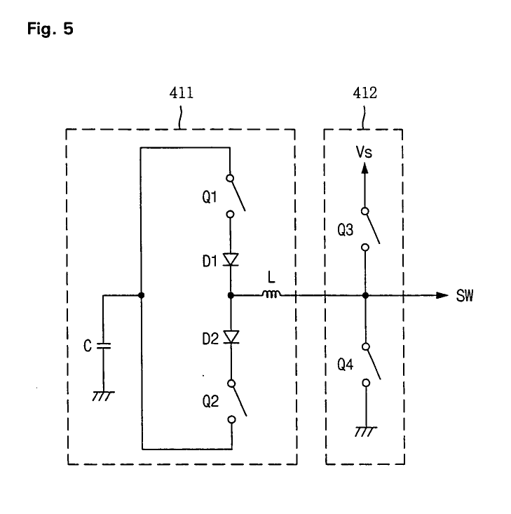

The Y-Z integration sustain circuit unit 410 supplies the sustain pulse (SUSP) to the scan electrode (Y) and the sustain electrode (Z) of the panel capacitor (Cp). The Y-Z integration sustain circuit unit 410 comprises a single energy recovery circuit unit (not shown) and a single sustain pulse creation unit (not shown) to supply the sustain pulse to the two electrodes. A detailed construction thereof will be later described with reference to FIG. 5.

The switch unit 420 connects at its one end with the scan electrode (Y) and the sustain electrode (Z), and connects at the other end with the Y-Z integration sustain circuit unit 410. The switch unit 420 controls the Y-Z integration sustain circuit unit 410 to alternately supply the sustain pulse (SUSP) to the scan electrode (Y) and the sustain electrode (Z).

The switch unit 420 can comprise a plurality of switch units. For example, in the switch unit 420, a first switch unit (SW1) and a second switch unit (SW2) can turn on in a push-pull form, and alternately supply the sustain pulse (SUSP) to the scan electrode (Y) and the sustain electrode (Z).

For example, in the first embodiment of the present invention shown in FIG. 4, the first switch unit (SW1) of the switch unit 420 can be connected between the Y-Z integration sustain circuit unit 410 and the scan electrode (Y), and can control supplying of the sustain pulse applied to the scan electrode (Y). The second switch unit (SW2) can commonly connect at its one end between the Y-Z integration sustain circuit unit 410 and the first switch unit (SW1) and can connect at the other end to the sustain electrode (Z) to control supplying of the sustain pulse applied to the sustain electrode (Z).

In the plasma display apparatus according to the first embodiment of the present invention, the single sustain driving board 210 can further comprise a scan driver integrated circuit (IC) 400 for driving the scan electrode (Y).

The scan driver IC 400 can connect between the first switch unit (SW1) and the scan electrode (Y) and supply a setup pulse (Vsetup) and a setdown pulse (NR) of the reset period and the scan pulse (SCNP) of the address period to the scan electrode (Y).

A detailed construction of the Y-Z integration sustain circuit unit 410 of FIG. 4 provided at the single sustain driving board 210 according to the first embodiment of the present invention will be described with reference to FIG. 5 below. The Y-Z integration sustain circuit unit 410 of FIG. 5 is to make a construction and a function of the present invention more clear, and it should be noted not to intend to limit the construction of the present invention.

FIG. 5 is a diagram illustrating an example of a construction of the Y-Z integration sustain circuit unit of FIG. 4.

As shown in FIG. 5, in the plasma display apparatus according to the first embodiment of the present invention, the Y-Z integration sustain circuit unit 410 of FIG. 4 comprises a single energy recovery circuit unit 411 and a single sustain pulse creation unit 412.

The single energy recovery circuit unit 411 forms resonance through the same energy storing unit and the same inductor, supplies sustain pulse supplying energy to the scan electrode (Y) and the sustain electrode (Z) of the panel (Cp), and recovers unavailable energy of the panel (Cp).

For example, the single energy recovery circuit unit 411 comprises a common energy storing unit (C) for recovering and storing energy for supplying the sustain pulse toe the scan electrode (Y) and the sustain electrode (Z), and a common inductor (L) for supplying the energy stored in the common energy storing unit (C) to the scan electrode (Y) and the sustain electrode (Z) through the resonance.

The single energy recovery circuit unit 411 comprises a first switch unit (Q1), a first diode (D1), a second diode (D2), and a second switch unit (Q2) that connect in parallel between the common energy storing unit (C) and the common inductor (L).

The single sustain pulse creation unit 412 supplies the sustain pulse to the scan electrode (Y) and the sustain electrode (Z). For example, the single sustain pulse creation unit 412 comprises a third switch unit (Q3) connecting between a sustain voltage source for supplying the sustain voltage (Vs) and the common inductor (L), and a fourth switch unit (Q4) connecting between a base voltage source for supplying ground level (GND) voltage and the common inductor (L).

Operation of the Y-Z integration sustain circuit unit 410 will be described as follows. It is assumed that the common energy storing unit (C) is charged with voltage of Vs/2.

First, when the first switch unit (Q1) turns on, energy charged to the common energy storing unit (C) is supplied to the switch unit (SW) 420 of FIG. 4 via the first switch unit (Q1), the first diode (D1), and the inductor (L).

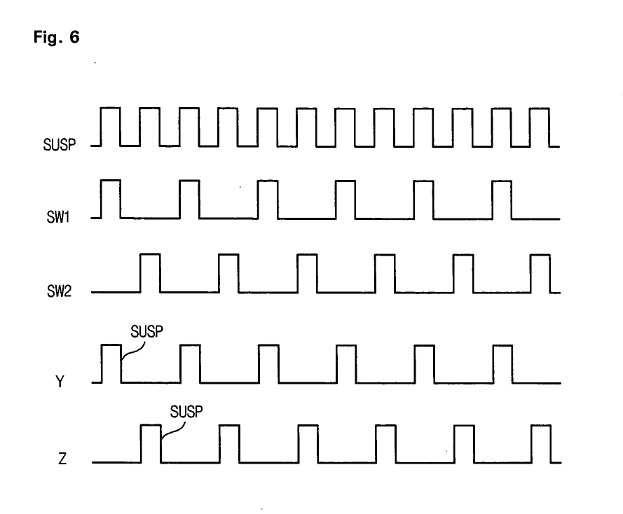

The switch unit (SW) 420 of FIG. 4 controls and supplies the energy to the scan electrode (Y) or the sustain electrode (Z) by predetermined switching operation. A more detailed description thereof will be made in from FIG. 6.

The inductor (L) constitutes a series LC resonance circuit with the capacitance (Cp) of the plasma display panel and therefore, voltage of Vs is supplied to the scan electrode (Y) line.

After that, a third switch unit (Q3) turns on. If the third switch unit (Q3) turns on, the sustain voltage (Vs) of the sustain pulse creation unit 412 is supplied to the switch unit (SW) of FIG. 4. The switch unit (SW) of FIG. 4 controls and supplies the sustain voltage (Vs) to the scan electrode (Y) or the sustain electrode (Z) by the predetermined switching operation. A more detailed description thereof will be made in from FIG. 6.

A voltage level on the scan electrode (Y) or the sustain electrode (Z) is sustained as the sustain voltage (Vs) and accordingly, the sustain discharge is generated in the discharge cells of the panel (Cp).

After generation of the sustain discharge, the second switch unit (Q2) turns on. If the second switch unit (Q2) turns on, reactive power is recovered from the scan electrode (Y) line or the sustain electrode (Z) line to the common energy storing unit (C) via the switch unit (SW), the inductor (L), the second diode (D2), and the second switch unit (Q2). In other words, the energy of the plasma display panel (Cp) is recovered to the common energy storing unit (C).

Next, the fourth switch unit (Q4) turns on, and voltage of the scan electrode (Y) line or the sustain electrode (Z) line is sustained as ground level electric potential (GND).

As described above, the Y-Z integration sustain circuit unit 410 recovers the unavailable energy from the plasma display panel (Cp) and then, supplies voltage to the scan electrode (Y) line or the sustain electrode (Z) line using the recovered energy, thereby reducing excessive consumption power when the plasma display panel (Cp) is driven.

As such, the inventive plasma display apparatus can reduce number of circuit logics and number of circuit devices owing to a construction of the Y-Z integration sustain circuit unit 410 capable of driving all of the scan electrode (Y) and the sustain electrode (Z).

Further, there is effect of reducing its manufacture cost and improving space utility, by making it possible to form driving circuits of such as the Y-Z integration sustain circuit unit 410 comprising the single energy recovery circuit unit 411 and the sustain pulse creation unit 412, the switch unit 420, and the scan driver IC 400, in a single driving board.

Further, there is effect of reducing load of the circuit unit requiring a high withstanding voltage characteristic, by controlling the sustain voltage (Vs) through the construction of the switch unit 420. Accordingly, switching voltage can be also reduced.

As such, the sustain voltage (Vs) can be controlled, thereby not needing to use a device having the high withstanding voltage characteristic of having to withstand high voltage such as conventional voltage magnitude of a difference between the sustain voltage (Vs) and other driving voltages.

This provides effect of being capable of not only reducing the manufacture cost, but also reducing output impedance using a device having a relative low withstanding characteristic. This can make it possible to reduce waveform noise and perform more accurate driving.

Further, accurate driving waveform can be supplied, thereby not only improving circuit stability but also greatly reducing influence of electromagnetic interference (EMI).

In the inventive plasma display apparatus, switching operation of the switch unit (SW) is used to drive all of the scan electrode (Y) and the sustain electrode (Z) through the Y-Z integration sustain circuit unit. A description of the switching operation of the switch unit (SW) will be described with reference to FIG. 6 below.

FIG. 6 is a diagram illustrating switch timing of the plasma display apparatus of FIG. 4 according to a first embodiment of the present invention.

As shown in FIG. 6, the Y-Z integration sustain circuit unit 410 of FIG. 5 generates a plurality of sustain pulses (SUSP) in the sustain period (SP) depending on a Y-Z integration timing control signal supplied from the control board 230, and alternately supplies the sustain pulse (SUSP) to the scan electrode (Y) or the sustain electrode (Z) by the switching operation of the switch unit 420.

According to the first embodiment of the present invention, the first switch unit (SW1) turns on when the sustain pulse (SUSP) is supplied to the scan electrode (Y), and the second switch unit (SW2) turns on when the sustain pulse (SUSP) is supplied to the sustain electrode (Z).

In the first embodiment of the switch timing, the first and second switch units (SW1 and SW2) can remain turned on during the duration of time being substantially the same as the duration of time for supplying the sustain pulse (SUSP).

In other words, by the turn on of the first switch unit (SW1), the sustain pulse (SUSP) is supplied to the scan electrode (Y) and, by the turn on of the second switch unit (SW2), the sustain pulse (SUSP) is supplied to the sustain electrode (Z).

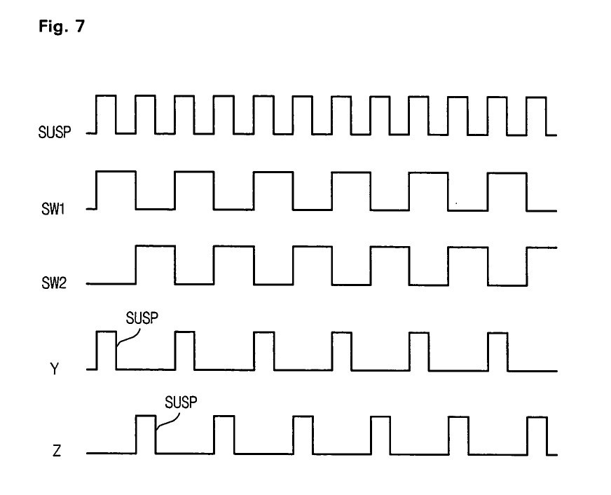

FIG. 7 is a diagram illustrating switch timing of the plasma display apparatus of FIG. 4 according to a second embodiment of the present invention.

As shown in FIG. 7, the Y-Z integration sustain circuit unit 410 of FIG. 5 generates a plurality of sustain pulses (SUSP) in the sustain period (SP) depending on a Y-Z integration timing control signal supplied from the control board 230, and alternately supplies the sustain pulse (SUSP) to the scan electrode (Y) or the sustain electrode (Z) by switching operation of the switch unit 420.

According to the first embodiment of the present invention, the first switch unit (SW1) turns on when the sustain pulse (SUSP) is supplied to the scan electrode (Y), and the second switch unit (SW2) turns on when the sustain pulse (SUSP) is supplied to the sustain electrode (Z).

In the second embodiment of the present invention, the first switch unit (SW1) in an on state turns off between a time point when the application of one sustain pulse (SUSP) to the scan electrode (Y) terminates and an application time point of one sustain pulse (SUSP) to the sustain electrode (Z) after applying one sustain pulse (SUSP) to the scan electrode (Y), and the second switch unit (SW2) in an on state turns off between a time point when the application of one sustain pulse (SUSP) to the sustain electrode (Z) terminates and an application time point of one sustain pulse (SUSP) to the scan electrode (Y) after applying one sustain pulse (SUSP) to the sustain electrode (Z).

For example, as shown in FIG. 7, the first and second switch units (SW1 and SW2) can remain turned on during about double of the duration of time for supplying the sustain pulse (SUSP). This is to, when the circuit is driven, reduce noise by differently driving a frequency.

In other words, if the sustain pulse creation unit 412 creates a pulse having substantially double frequency of the sustain pulse (SUSP), the switch unit 420 should turn on during about double of the duration of time for sustaining the sustain pulse (SUSP) to supply the sustain pulse (SUSP). As such, even in case where the frequency is differently increased or decreased, the switching timing can be controlled and variously driven.

As described above, the switching operation is used to supply the sustain pulse (SUSP) to the scan electrode (Y) and the sustain electrode (Z) from the same driver, thereby reducing ElectroMagnetic Interference (EMI) or interference caused by phase difference of the sustain pulse (SUSP) between two electrodes. Accordingly, the driving reliability can be improved.

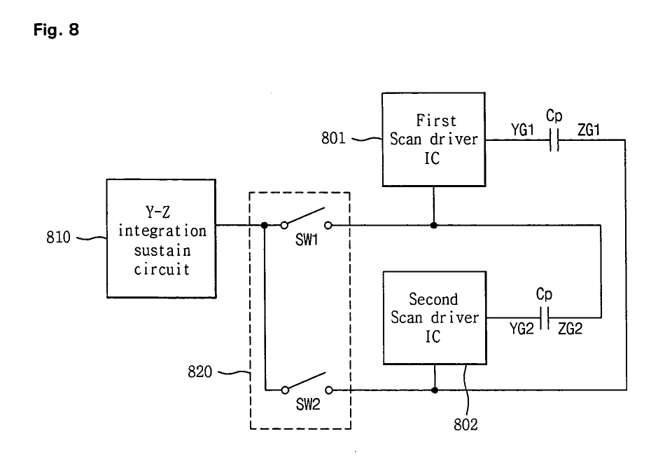

FIG. 8 is a diagram illustrating a single sustain driving board of a plasma display apparatus according to a second embodiment of the present invention.

As shown in FIG. 8, The plasma display apparatus according to the second embodiment of the present invention comprises an equivalent capacitor (Cp) of a plasma display panel and the single sustain driving board 210. The single sustain driving board 210 may comprise a Y-Z integration sustain circuit unit 810 and a switch unit 820.

The Y-Z integration sustain circuit unit 810 comprise a single energy recovery circuit unit (not shown) for storing unavailable energy of the panel capacitor (Cp) and supplying energy to a scan electrode (Y) and a sustain electrode (Z), and a single sustain pulse creation unit (not shown) for supplying a sustain pulse (SUSP) to the scan electrode (Y) and the sustain electrode (Z). An example of a detailed construction thereof is described with reference to FIG. 5 and therefore, will be omitted.

In the second embodiment of the present invention of FIG. 8, a first switch unit (SW1) of the switch unit 820 connects at its one end with the Y-Z integration sustain circuit unit 810, and commonly connects at the other end with a first scan electrode group (YG1) of a plurality of scan electrodes and a second sustain electrode group (ZG2) of a plurality of sustain electrodes. If the first switch unit (SW1) turns on, a first sustain pulse is concurrently supplied to the first scan electrode group (YG1) and the second sustain electrode group (ZG2).

The second switch unit (SW2) of the switch unit 820 commonly connects at its one end between the Y-Z integration sustain circuit unit 810 and the first switch unit (SW1), and commonly connects at the other end with a second scan electrode group (YG2) of the plurality of scan electrodes and a first sustain electrode group (ZG1) of the plurality of sustain electrodes. If the second switch unit (SW2) turns on, a second sustain pulse is supplied, alternately with the first sustain pulse, to the second scan electrode group (YG2) and the first sustain electrode group (ZG1).

In the plasma display apparatus according to the second embodiment of the present invention, the single sustain driving board 210 can further comprise scan driver integrated circuits (ICs) 801 and 802 for driving the scan electrode (Y).

The scan driver ICs comprise a first scan driver IC 801 connecting between the first switch unit (SW1) and the first scan electrode group (YG1), and a second scan driver IC 802 connecting between the second switch unit (SW2) and the second scan electrode group (YG2).

The first scan driver IC 801 can supply a setup pulse (Vsetup) and a setdown pulse (NR) of a reset period and a scan pulse (SCNP) of an address period to the first scan electrode group (YG1). The second scan driver IC 802 can supply the setup pulse (Vsetup) and the setdown pulse (NR) of the reset period and the scan pulse (SCNP) of the address period to the second scan electrode group (YG2).

The plurality of scan electrodes can be divided into the first scan electrode group (YG1) and the second scan electrode group (YG2), and the plurality of sustain electrodes can be divided into the first sustain electrode group (ZG1) and the second sustain electrode group (ZG2). As such, the dividing and driving the electrodes into the group is to reduce the load applied to the panel.

For example, upper and half of the plurality of scan electrodes can be divided as the first scan electrode group (YG1), and lower and half of the scan electrodes can be divided into the second scan electrode group (YG2). Upper and half of the plurality of sustain electrodes can be divided into the first sustain electrode group (ZG1), and lower and half of the sustain electrodes can be divided into the second sustain electrode group (ZG2). As such, when the sustain pulse is applied, the panel is divided into and driven with upper and lower portions, thereby providing effect of reducing a half and more of the panel load.

In other words, the equivalent capacitor (Cp) of the plasma display panel corresponds to a total sum of capacitances provided between the scan electrode (Y) and the sustain electrode (Z). This capacitance is a factor of having important influence on the driving.

In the second embodiment of the present invention, for example, the sustain pulse can be applied to the scan electrodes (YG1) of an upper portion of the panel and at the same time, the sustain pulse can also be applied to the sustain electrodes (ZG2) of a lower portion.

Further, when the sustain pulse is applied to the scan electrodes (YG2) of the lower portion of the panel, the sustain pulse can be applied to the sustain electrodes (ZG1) of the upper region, thereby reducing the capacitance between the scan electrode (Y) and the sustain electrode (Z). Accordingly, consumption power can be saved, and thermal load of the driving circuit caused by increase of a panel size can also be reduced. Further, a drawback of heat emission of the circuit caused by peak current is solved, thereby greatly improving reliability of the driving circuit.

Even in the plasma display apparatus according to the second embodiment of the present invention, similarly with the first embodiment, it is possible to form the Y-Z integration sustain circuit 810 comprising the single energy recovery circuit unit (not shown) and the sustain pulse creation unit (not shown), the switch unit 820, and the driving circuit such as the first scan driver IC 801 and the second scan driver IC 802, on the single driving board, thereby providing effect of reducing the manufacture cost of the plasma display apparatus and improving space utility. Other effects are described above and therefore, will be omitted.

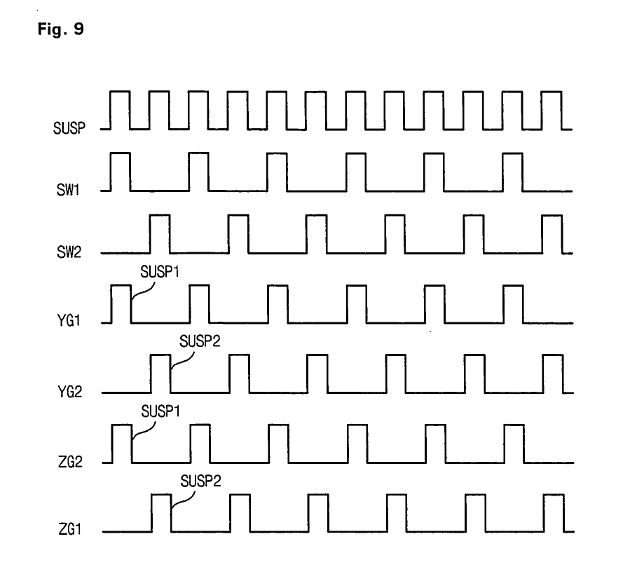

The switch unit 820 of FIG. 8 controls and supplies the sustain voltage (Vs) from the Y-Z integration sustain circuit unit 810 to the scan electrode (Y) and the sustain electrode (Z) by predetermined switching operation. A detailed description thereof will be described with reference to FIG. 9 below.

FIG. 9 is a diagram illustrating switch timing of the plasma display apparatus of FIG. 8 according to a first embodiment of the present invention.

As shown in FIG. 9, the Y-Z integration sustain circuit unit 810 of FIG. 8 generates the plurality of sustain pulses (SUSP) in the sustain period (SP) depending on a Y-Z integration timing control signal, and alternately supplies the sustain pulse (SUSP) to the scan electrode (Y) or the sustain electrode (Z) by the switching operation of the switch unit 820.

In the switch timing according to the first embodiment of the present invention, the first switch unit (SW1) turns on when the first sustain pulse (SUSP1) is supplied to the first scan electrode group (YG1) and the second sustain electrode group (ZG2), and the second switch unit (SW2) turns on when the second sustain pulse (SUSP2) is supplied to the second scan electrode group (YG2) and the first sustain electrode group (ZG1).

In the switch timing according to the first embodiment shown in FIG. 9, the first and second switch units (SW1 and SW2) can remain turned on during the duration of time being substantially the same as the duration of time for supplying the sustain pulse (SUSP).

In other words, by the turn on of the first switch unit (SW1), the first sustain pulse (SUSP) is supplied to the first scan electrode group (YG1) and the second sustain electrode group (ZG2) and, by the turn on of the second switch unit (SW2), the second sustain pulse (SUSP2) alternating with the first sustain pulse is supplied to the second scan electrode group (YG2) and the first sustain electrode group (ZG1).

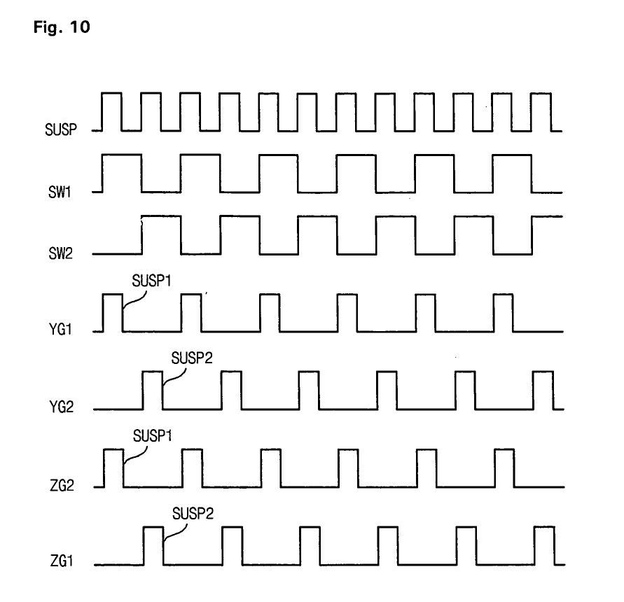

FIG. 10 is a diagram illustrating switch timing of the plasma display apparatus of FIG. 8 according to a second embodiment of the present invention.

As shown in FIG. 10, the Y-Z integration sustain circuit unit 810 of FIG. 8 generates the plurality of sustain pulses (SUSP) in the sustain period (SP) depending on a Y-Z integration timing control signal, and alternately supplies the sustain pulse (SUSP) to the scan electrode (Y) or the sustain electrode (Z) by the switching operation of the switch unit 820.

In the switch timing according to the second embodiment of the present invention, the first switch unit (SW1) turns on when the first sustain pulse (SUSP1) is supplied to the first scan electrode group (YG1) and the second sustain electrode group (ZG2), and the second switch unit (SW2) turns on when the second sustain pulse (SUSP2) is supplied to the second scan electrode group (YG2) and the first sustain electrode group (ZG1).

In the switch timing according to the second embodiment, the first switch unit (SW1) in an on state turns off between a time point when the application of one sustain pulse (SUSP) to the first scan electrode group (YG1) and to the second sustain electrode group (ZG2) terminates and an application time point of one sustain pulse (SUSP) to the second scan electrode group (YG2) and to the first sustain electrode group (ZG1) after applying one sustain pulse (SUSP) to the first scan electrode group (YG1) and to the second sustain electrode group (ZG2), and the second switch unit (SW2) in an on state turns off between a time point when the application of one sustain pulse (SUSP) to the second scan electrode group (YG2) and to the first sustain electrode group (ZG1) terminates and an application time point of one sustain pulse (SUSP) to the first scan electrode group (YG1) and to the second sustain electrode group (ZG2) after applying one sustain pulse (SUSP) to the second scan electrode group (YG2) and to the first sustain electrode group (ZG1).

For example, as shown in FIG. 10, the first and second switch units (SW1 and SW2) can remain turned on during about double of the duration of time for supplying the sustain pulse (SUSP). This is to, when the circuit is driven, reduce noise by differently driving a frequency. This is described above and therefore, a detailed description thereof will be omitted.

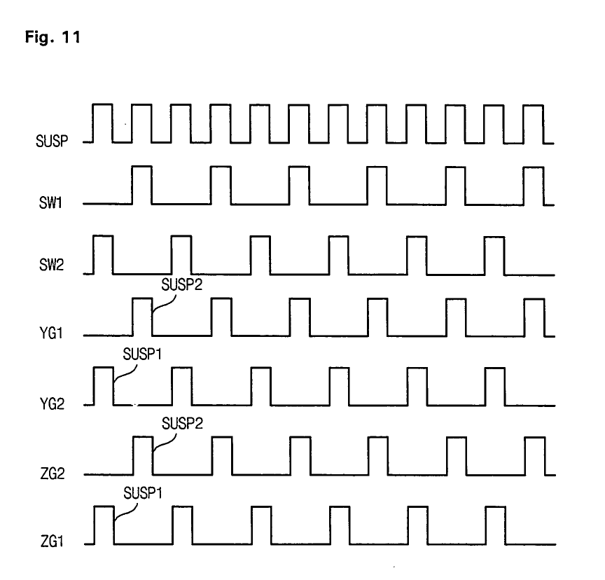

FIG. 11 is a diagram illustrating switch timing of the plasma display apparatus of FIG. 8 according to a third embodiment of the present invention.

As shown in FIG. 11, the Y-Z integration sustain circuit unit 810 of FIG. 8 generates the plurality of sustain pulses (SUSP) in the sustain period (SP) depending on a Y-Z integration timing control signal, and alternately supplies the sustain pulse (SUSP) to the scan electrode (Y) or the sustain electrode (Z) by the switching operation of the switch unit 820.

In the switch timing according to the third embodiment of the present invention, the first switch unit (SW1) turns on when the first sustain pulse (SUSP1) is supplied to the first scan electrode group (YG1) and the second sustain electrode group (ZG2), and the second switch unit (SW2) turns on when the second sustain pulse (SUSP2) is supplied to the second scan electrode group (YG2) and the first sustain electrode group (ZG1).

In the switch timing of FIG. 11 according to the third embodiment, the second switch unit (SW2) first turns on so that the first sustain pulse (SUSP1) can be supplied to the second scan electrode group (YG2) and the first sustain electrode group (ZG1). After that, the first switch unit (SW1) turns on so that the second sustain pulse (SUSP2) can be supplied to the first scan electrode group (YG1) and the second sustain electrode group (ZG2).

Other constructions are the same as the switch timing of FIG. 9 according to the first embodiment and therefore, will be omitted below.

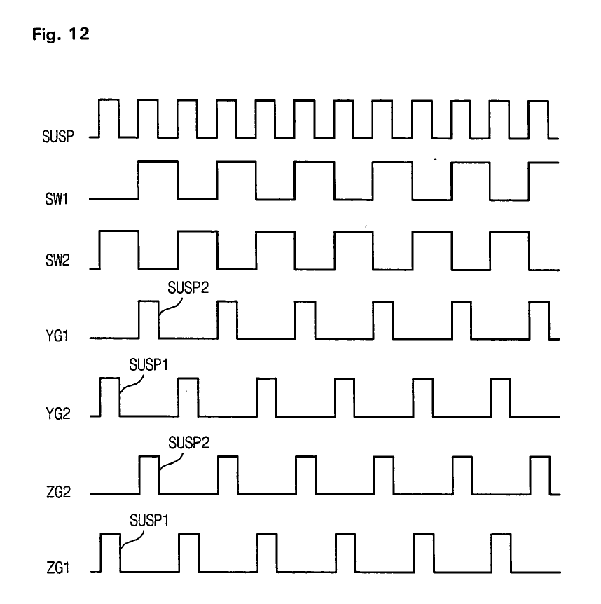

FIG. 12 is a diagram illustrating switch timing of the plasma display apparatus of FIG. 8 according to a fourth embodiment of the present invention.

As shown in FIG. 12, the Y-Z integration sustain circuit unit 810 of FIG. 8 generates the plurality of sustain pulses (SUSP) in the sustain period (SP) depending on a Y-Z integration timing control signal, and alternately supplies the sustain pulse (SUSP) to the scan electrode (Y) or the sustain electrode (Z) by the switching operation of the switch unit 820.

In the switch timing according to the fourth embodiment of the present invention, the first switch unit (SW1) turns on when the first sustain pulse (SUSP1) is supplied to the first scan electrode group (YG1) and the second sustain electrode group (ZG2), and the second switch unit (SW2) turns on when the second sustain pulse (SUSP2) is supplied to the second scan electrode group (YG2) and the first sustain electrode group (ZG1).

In the switch timing of FIG. 12 according to the fourth embodiment, the second switch unit (SW2) first turns on so that the first sustain pulse (SUSP1) can be supplied to the second scan electrode group (YG2) and the first sustain electrode group (ZG1). After that, the first switch unit (SW1) turns on so that the second sustain pulse (SUSP2) can be supplied to the first scan electrode group (YG1) and the second sustain electrode group (ZG2).

Other constructions are the same as the switch timing of FIG. 10 according to the second embodiment and therefore, will be omitted below.

As described above, the switching operation is used to supply the sustain pulse (SUSP) to the scan electrode (Y) and the sustain electrode (Z) from the same driver, thereby reducing bad influence from EMI or interference caused by phase difference of the sustain pulse (SUSP) between two electrodes. Accordingly, the driving reliability can be improved.

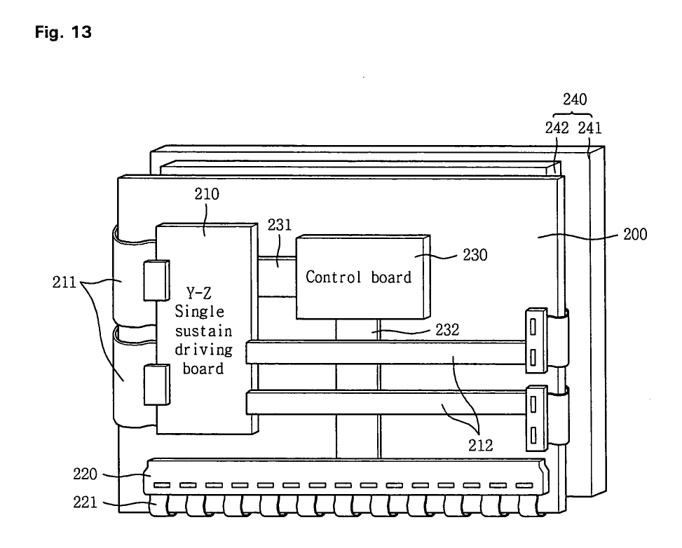

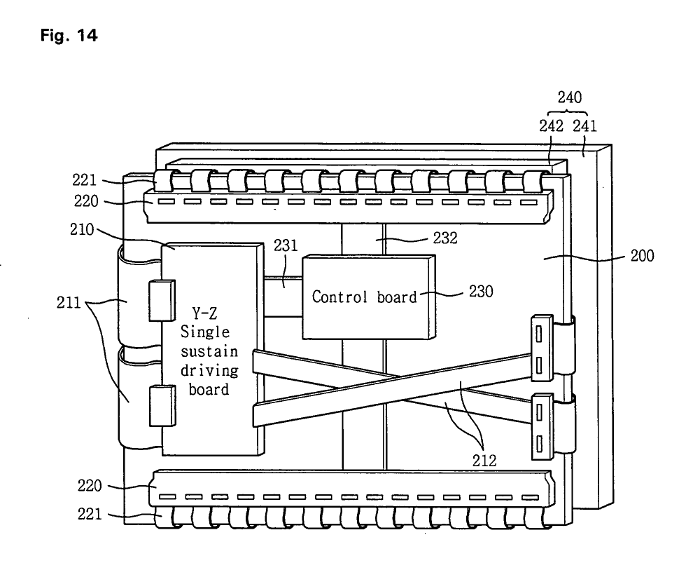

Another embodiment of the connection relation between the plasma display panel and the driver described with reference to FIG. 2 will be described with reference to FIGS. 13 and 14 below.

FIG. 13 is a diagram illustrating connection relation between a plasma display panel and a driver according to another embodiment of the present invention.

As shown in FIG. 13, the inventive plasma display apparatus can comprise a plasma display panel 240 having a front panel 241 and a rear panel 242 sealed with each other, and displaying images; a frame 200 provided in rear of the plasma display panel 240; and a single sustain driving board 210, a data driver board 220, a control board 230, and a supply source board (not shown) capable of being provided on the frame 200.

Unlike the construction of FIG. 2, connection position of the single sustain driving board 210 with the control board 230 is different. In other words, the control board 230 is formed slightly to an upper side of the panel, thereby reducing electrical interference with the data driver board 220 and accordingly, also changing positions of the FPC 231 and the common electrode line 212.

Such a position of the driver can have great influence on a driving characteristic. In other words, the positions of the drivers 210, 220, and 230 can be adaptively selected in consideration of the load of the plasma display panel.

Descriptions of other constructions are duplicated with those of the constructions of FIG. 2 and therefore, will be omitted.

FIG. 14 is a diagram illustrating connection relation between a plasma display panel and a driver according to a further embodiment of the present invention.

As shown in FIG. 14, the inventive plasma display apparatus can comprise a plasma display panel 240 having a front panel 241 and a rear panel 242 sealed with each other, and displaying images; a frame 200 provided in rear of the plasma display panel 240; and a single sustain driving board 210, a data driver board 220, a control board 230, and a supply source board (not shown) capable of being provided on the frame 200.

In the embodiment of FIG. 14, unlike the construction of FIG. 13, the data driver board 220 is provided in pair as drivers of a dual scan driving method at upper and lower parts of the panel. Further, two common electrode lines 212 for connecting the single sustain driving board 210 with the sustain electrode (Z) can be provided in a cross form.

Descriptions of other constructions are duplicated with those of the constructions of FIG. 2 and therefore, will be omitted.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode; and
a single sustain driving board comprising a single energy recovery circuit unit for supplying energy to supply a sustain pulse through a same energy storing unit and a same inductor to the scan electrode and to the sustain electrode, and a single sustain pulse creation unit for supplying the sustain pulse to the scan electrode and to the sustain electrode.

2. The plasma display apparatus of claim 1, wherein the single sustain driving board comprises a switch unit, one end connecting to the scan electrode and the sustain electrode and the other end connecting to the single energy recovery circuit unit, for alternately supplying the sustain pulse to the scan electrode and the sustain electrode.

3. The plasma display apparatus of claim 2, wherein the switch unit comprises a first switch unit and a second switch unit that turn on in a push-pull form for alternately supplying the sustain pulse to the scan electrode and the sustain electrode.

4. The plasma display apparatus of claim 1, wherein one end of the single sustain driving board connects to the scan electrode through an electrode pad and the other end connects to a plurality of sustain electrodes, that are commonly connected, through a common electrode line.

5. The plasma display apparatus of claim 4, wherein the common electrode line is a plurality of common electrode lines, wherein each common electrode line that connects to an amount the sustain electrodes that is less the total number of sustain electrodes in the plurality of sustain electrodes.

6. The plasma display apparatus of claim 5, wherein the number of common electrode lines equals two.

7. A plasma display apparatus comprising:
a plasma display panel comprising a scan electrode and a sustain electrode;
a single energy recovery circuit unit for controlling the application of a sustain pulse to the scan electrode and the sustain electrode;
a first switch unit, connected between the single energy recovery circuit and the scan electrode, for controlling the application of a sustain pulse to the scan electrode; and
a second switch unit, one end commonly connecting between the single energy recovery circuit and the first switch unit and the other end connecting to the sustain electrode, for controlling the application of the sustain pulse to the sustain electrode.

8. The plasma display apparatus of claim 7, wherein the single energy recovery circuit comprises:
a common energy storing unit for recovering and storing the energy to supply the sustain pulse to the scan electrode and the sustain electrode; and
a common inductor for supplying the energy stored in the common energy storing unit to the scan electrode and the sustain electrode.

9. The plasma display apparatus of claim 7, further comprising a scan driver IC connected between the first switch unit and the scan electrode.

10. The plasma display apparatus of claim 9, wherein the single energy recovery circuit unit, the first switch unit, the second switch unit and the scan driver are formed on a single driving board.

11. The plasma display apparatus of claim 7, wherein the supplying of a sustain pulse to the scan electrode turns on the first switch unit, and the supplying of a sustain pulse to the sustain electrode turns on the second switch unit.

12. The plasma display apparatus of claim 11, wherein the duration of time that each of the first and second switch units remains turned on is substantially the same as the duration of time for supplying the sustain pulse.

13. The plasma display apparatus of claim 11, wherein the first switch unit in an on state turns off between a time point when the application of one sustain pulse to the scan electrode terminates and an application time point of one sustain pulse to the sustain electrode after applying one sustain pulse to the scan electrode, and the second switch unit in an on state turns off between a time point when the application of one sustain pulse to the sustain electrode terminates and an application time point of one sustain pulse to the scan electrode after applying one sustain pulse to the sustain electrode.

14. A plasma display apparatus comprising:
a plasma display panel comprising a plurality of scan electrodes and a plurality of sustain electrodes;
a single energy recovery circuit unit for controlling the application of a sustain pulse to the scan electrodes and the sustain electrodes;
a first switch unit for simultaneously supplying a first sustain pulse to a first scan electrode group of the plurality of scan electrodes and a second sustain electrode group of the plurality of sustain electrodes; and
a second switch unit for alternately supplying a second sustain pulse to a second scan electrode group of the plurality of scan electrodes and to a first sustain electrode group of the plurality of sustain electrodes.

15. The plasma display apparatus of claim 14, wherein the single energy recovery circuit comprises:
a common energy storing unit for recovering and for storing energy to supply the sustain pulse to the scan electrode and the sustain electrode; and
a common inductor for supplying the energy stored in the common energy storing unit to the scan electrode and the sustain electrode.

16. The plasma display apparatus of claim 14, further comprising a first scan driver, connected between the first switch unit and the first scan electrode group; and
a second scan driver, connected between the second switch unit and the second scan electrode group.

17. The plasma display apparatus of claim 16, wherein one end of the first switch unit connects to the single energy recovery circuit unit and the other end commonly connects to the first scan driver and the second sustain electrode group, and
one end of the second switch unit commonly connects between the single energy recovery circuit and the first switch unit and the other end commonly connects to the second scan driver and the first sustain electrode group.

18. The plasma display apparatus of claim 16, wherein the single energy recovery circuit unit, the first switch unit, the second switch unit and the scan driver are formed on a single driving board.

19. The plasma display apparatus of claim 14, wherein the first scan electrode group is formed on an upper half portion of the plasma display panel and the second scan electrode group is formed on a lower half portion of the plasma display panel, and
wherein the first sustain electrode group is formed on the upper half portion of the plasma display panel and the second sustain electrode group is formed on the lower half portion of the plasma display panel.

20. The plasma display apparatus of claim 14, wherein the supplying of the first sustain pulse to the first scan electrode group and the second sustain electrode group turns on the first switch unit, and
the supplying of the second sustain pulse to the second scan electrode group and the first sustain electrode group turns on the second switch unit.

21. The plasma display apparatus of claim 20, wherein the duration of time that each of the first and second switch units remains turned on is substantially the same as the duration of time for supplying the sustain pulse.

22. The plasma display apparatus of claim 20, wherein the first switch unit in an on state turns off between a time point when the application of one sustain pulse to the first scan electrode group and to the second sustain electrode group terminates and an application time point of one sustain pulse to the second scan electrode group and to the first sustain electrode group after applying one sustain pulse to the first scan electrode group and to the second sustain electrode group, and the second switch unit in an on state turns off between a time point when the application of one sustain pulse to the second scan electrode group and to the first sustain electrode group terminates and an application time point of one sustain pulse to the first scan electrode group and to the second sustain electrode group after applying one sustain pulse to the second scan electrode group and to the first sustain electrode group.

23. A driving method of a plasma display apparatus comprising a plasma display panel comprising a scan electrode and a sustain electrode, the method comprising the steps of:
supplying energy to supply a sustain pulse from a single energy recovery circuit to the scan electrode and the sustain electrode; and
generating a pulse with a frequency of about two times a frequency of a sustain pulse applied to the scan electrode and the sustain electrode from a single sustain pulse generator.

24. The method of claim 23, wherein the switch unit alternately supplies the sustain pulse to the scan electrode and the sustain electrode through predetermined switching operation.

25. The method of claim 24, wherein the duration of time that the switch unit remains turned on is substantially the same as about two times of the duration of time for supplying the sustain pulse.
